(19) United States
(12) Patent Application Publication
(10) Pub. No.: US 2026/0049001 A1
(43) Pub. Date: Feb. 19, 2026

(54) METHOD FOR PRODUCING ULTRA HIGH PURE MANGANESE SULFATE MONOHYDRATE

(71) Applicant: BIOPHORE INDIA PHARMACEUTICALS PVT. LTD, Hyderabad (IN)

(72) Inventors: Manik Reddy PULLAGURLA, Hyderabad (IN); Kiran Kumar KOTHAKONDA, Hyderabad (IN); Bhaskar Reddy PITTA, Hyderabad (IN); Ramesh KOTIKALAPUDI, Hyderabad (IN); Jagadeesh Babu RANGISETTY, Hyderabad (IN)

(21) Appl. No.: 19/103,868

(22) PCT Filed: Aug. 16, 2023
(86) PCT No.: PCT/IB2023/058226

§ 371 Date: Feb. 14, 2025

(30) Foreign Application Priority Data
Aug. 16, 2022 (IN) 202241046454

(51) Int. Cl. C01G 45/10

(52) U.S. Cl. CPC C01G 45/10; C01P 2002/72; C01P 2006/80

(57) ABSTRACT

The present invention relates to a process for the purification of Manganese sulfate monohydrate (1). The present invention also specifically relates to a cost-effective process for the preparation of pharmaceutical grade Manganese sulfate monohydrate (1) having purity greater than 99.9998% (w/w).

### FIELD OF THE INVENTION

The present invention relates to a process for the purification of Manganese sulfate monohydrate. The present invention specifically relates to cost effective process for the preparation of pharmaceutical grade Manganese sulfate monohydrate (1) having purity greater than 99.9998% (w/w).

### BACKGROUND OF THE INVENTION

Manganese occurs in the earth's crust as ores such as pyrolusite (MnO₂), Rhodocrosite (MnCO₃), Manganite (Mn₂O₃·H₂O), Hausmannite (Mn₃O₄), Biotite mica (K (Mg, Fe) 3 (AlSi₃O₁₀) (OH)₂) and Amphibole ((Mg, Fe)₇Si₈O₂₂(OH)₂). Manganese oxide and carbonate ores are two main natural sources for extraction of manganese. Due to similar geochemical properties, Manganese is found in minerals along with iron. It is understood that commercial sources of manganese (MnO2 and MnSO4) contain significant level of iron contamination which makes it challenging to prepare high pure manganese dietary supplement.

Overdose of iron through supplements for long term would lead to chronic iron overload disorder. Iron toxicity can increase the level of free iron in the body. Free iron is pro-oxidant and may cause damage to cells. Excess iron accumulates in the internal organs and can cause fatal damage to brain and liver. Higher levels of free iron stimulate the growth of bacteria and viruses which increase the risk of infection.

U.S. Pat. No. 9,365,912 of Industry Foundation of Chonnam National University reported a process for producing electronical application grade manganese sulfate monohydrate (MnSO₄·H₂O) having purity 99.9%, which comprises leaching manganese from a low-purity manganese-containing substance with sulfuric acid (H₂SO₄) and a reductant to give a first manganese leachate; obtaining a second manganese leachate by removing a first impurity from the first manganese leachate with calcium hydroxide (Ca(OH)₂); obtaining a third manganese leachate by removing a second impurity from the second manganese leachate with a sulfide; precipitating manganese as a manganese oxide by adjusting pH of the third manganese leachate with sodium hydroxide (NaOH); re-dissolving the manganese oxide with sulfuric acid; drying the re-dissolved manganese oxide to afford high-purity manganese sulfate monohydrate (MnSO₄·H₂O).

The drawbacks of the prior art process for producing manganese sulfate monohydrate is having purity 99.9% means it is having 1000 ppm metal impurities. Prior-art process lack of purification process for producing pharmaceutical grade manganese sulfate monohydrate. Hence, the inventors herby disclose an improved process for the preparation of highly pure manganese sulfate monohydrate.

The present invention compared with prior art has following economically and industrial advantages:
(1) Process of the present invention is simple, cost-effective, commercially viable and produces ultra-high-pure manganese sulfate monohydrate.
(2) Manganese sulfate monohydrate having purity ≥99.9998%, the content of metallic impurity lead, arsenic, cadmium, mercury, iron, zinc, and aluminum all below 25 ppm.
(3) A simple and industrially scalable purification with neutral carbon treatment followed by cation-exchange resin was used for producing Manganese sulfate monohydrate. The cation-exchange resin can be recycled multiple times.

### OBJECTIVE OF THE INVENTION

In one objective, the present invention relates to a process for the preparation of ultra-pure manganese sulfate monohydrate (1).

In another objective, the present invention provides a process for purification of manganese sulfate monohydrate (1) having purity greater than 99.9998% (w/w).

Another objective of the invention was to take a commercially available low purity manganese sulfate and prepare an ultra-pure manganese sulfate by sequential treatment with carbon followed by cation resin.

Yet another objective of the present invention provides crystalline form of manganese sulfate monohydrate (1) and the process for preparing the same.

In further objective of the present invention provides an improved process for the preparation of Manganese sulfate monohydrate (1), having quality specifications as per new FDA-imposed quality standards and the ICH Q3D guidelines.

### SUMMARY OF THE INVENTION

The present invention relates to a process for producing ultra-pure Manganese sulfate monohydrate (1).

In one aspect of the present invention provides a process for producing ultra-pure Manganese sulfate monohydrate (1), comprising:
a) dissolving the wet solid manganese sulfate monohydrate (1) in water;
b) subjecting the reaction mixture to SC-40 carbon treatment;
c) heating the reaction mixture to a suitable temperature;
d) filtering the reaction mass and diluting with water;
e) cooling the reaction mass and passing the reaction mass through cation-exchange resin thereby washing the resin with water; and
f) distilling the collected mass from resin under vacuum to get highly pure Manganese sulfate monohydrate (1).

In another aspect of the present invention provides an improved process for the recrystallization of Manganese sulfate monohydrate (1), comprising:
1) dissolving the wet solid Manganese sulfate monohydrate (1) in a suitable solvent,
2) heating the reaction mass to a suitable temperature and stirred
3) cooling the reaction mass to a suitable temperature,
4) adding anti-solvent to the reaction mass and stirred,
5) filtering the solid, washing with anti-solvent, and
6) drying the solid to get the highly pure Manganese sulfate monohydrate (1).

In another aspect of the present invention provides a process for the preparation of Manganese sulfate monohydrate (1), as shown in scheme 1, comprising:
i. reacting Manganese dioxide with sulphur dioxide gas and water to obtain Manganese sulfate monohydrate (1).
ii. purifying or recrystallizing Manganese sulfate monohydrate (1) to obtain pure Manganese Sulfate Monohydrate (1).

In yet another aspect, the present invention provides a process for the preparation of Manganese sulfate monohydrate (1), having quality specifications as per new FDA-imposed quality standards and the ICH Q3D guidelines.

### BRIEF DESCRIPTION OF THE DRAWINGS

FIG. 1 illustrates X-Ray Diffraction (XRD) pattern of Manganese sulfate monohydrate (1)

### DETAILED DESCRIPTION OF THE INVENTION

The present invention relates to a process for producing ultra-high pure Manganese sulfate monohydrate (1).

In one embodiment of the present invention relates to a process for producing ultra-high pure Manganese sulfate monohydrate (1), comprising:
a) dissolving the wet solid manganese sulfate monohydrate (1) in water;
b) subjecting the reaction mixture to SC-40 carbon treatment;
c) heating the reaction mixture to a suitable temperature;
d) filtering the reaction mass and diluting with water;
e) cooling the reaction mass and passing the reaction mass through cation-exchange resin thereby washing the resin with water; and
f) distilling the collected mass from resin under vacuum to get highly pure Manganese sulfate monohydrate (1).

Wherein, the cation-exchange resin used in step d) is selected from Dowex 50W, Amberlite IR-120, Amberjet 1200H, INDION BSR Na+ or INDION SIR Na+, preferably using INDION SIR Na+.

In another embodiment of the present invention provides the cation-exchange resin used for the present invention can be recycled multiple times.

In yet another embodiment, impurities lead arsenic, cadmium, mercury, iron zinc aluminium are controlled as per ICH Q3D guidelines.

In another embodiment of the present invention provides an improved process for the recrystallization of Manganese sulfate monohydrate (1), comprising:
1) dissolving the wet solid Manganese sulfate monohydrate (1) in a suitable solvent,
2) heating the reaction mass to a suitable temperature and stirred
3) cooling the reaction mass to a suitable temperature,
4) adding anti-solvent to the reaction mass and stirred,
5) filtering the solid, washing with anti-solvent, and
6) drying the solid to get the highly pure Manganese sulfate monohydrate (1).
wherein, the suitable solvent used in step 1) is water; anti-solvent used in step 4) & 5) is selected from methanol, ethanol, propanol, isopropanol, n-butanol, or mixtures thereof, preferable using ethanol.

In another embodiment, the present invention provides a process for the preparation of Manganese sulfate monohydrate (1), which is illustrated in scheme 1:

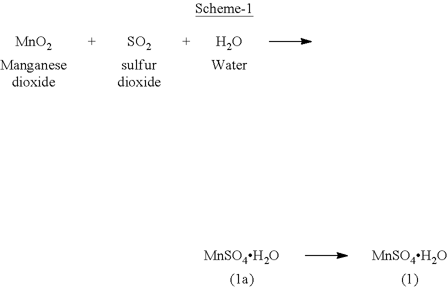

The process comprises:
Step a) involves reacting Manganese dioxide with sulphur dioxide gas and water to obtain Manganese sulfate monohydrate crude (1a).
Step b) involves purifying or recrystallizing Manganese sulfate monohydrate (1) to obtain Manganese Sulfate Monohydrate (1).

In another embodiment, Manganese sulfate forms different hydrates viz-a-viz., monohydrate, dihydrate, Penta hydrate, and heptahydrates. Preferably forms Manganese sulfate monohydrate.

In another embodiment, the present invention provides a process for the preparation of Manganese sulfate monohydrate (1), having quality specifications as per new FDA-imposed quality standards and the ICH Q3D guidelines.

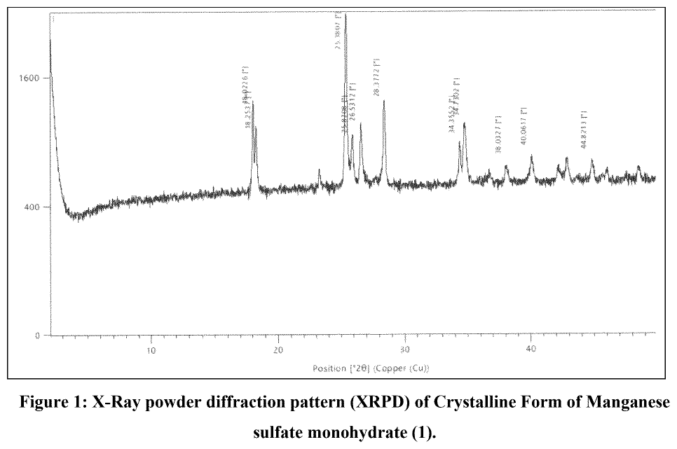

In another embodiment, crystalline form of Manganese sulfate monohydrate (1) obtained according to the present invention is characterised by X-ray powder diffractions (XRD) pattern as shown in FIGS. 1 and 2 theta values as provided in Table 1:

TABLE 1

| Two theta (2Θ) values | Relative Intensity I/Io (%) |
|---|---|
| 18.02 | 41.12 |
| 18.25 | 24.84 |
| 25.38 | 100.00 |
| 25.87 | 20.29 |
| 26.53 | 27.31 |
| 28.37 | 43.51 |
| 34.35 | 18.39 |
| 34.73 | 28.93 |
| 38.03 | 6.36 |
| 40.06 | 10.91 |
| 44.82 | 7.87 |

In another embodiment, the Manganese sulfate monohydrate (1) obtained according to the present invention is having water content less than 13% (w/w), more preferably less than 10% (w/w).

In another embodiment, the solid Manganese sulfate monohydrate (1) obtained according to the present invention is crystalline powder.

In another embodiment, the solid Manganese sulfate monohydrate (1) obtained according to the present invention can be dried to produce anhydrous form.

In another embodiment, INDION SIR Na⁺ or equivalent resins can be used in the process.

In an embodiment, commercially available manganese sulfate monohydrate is in impure form, which is purified by the present invention using Indion SIR Na+ resin to get highly pure compound.

The best mode of carrying out the present invention is illustrated by the below mentioned examples. These examples are provided as illustration only and hence should not be considered as limitation of the scope of the invention.

### EXAMPLES

### Example-1: Process for the Preparation of Manganese Sulfate Monohydrate (1)

Take a clean and dry round bottom flask, 100.0 g of manganese dioxide was added to 500 mL of water. The reaction mixture was stirred for 1 hour at 25-30° C. The obtained solid was filtered and washed with water, then suck dried for 30-40 minutes. 500 ml of water was added to the wet material and cooled to 10-20° C. Sulphur dioxide gas was purged into reaction mass at 10-20° C. After completion of gas purging, the reaction mass was stirred for 3-4 hours at 20-30° C. Filtered and distilled the reaction mass completely at below 70° C. 40 ml of water was added to the reaction mass and slowly stirred for 10-15 min. The obtained solid was filtered and washed with water to get the title compound.

### Example-2: Process for the Purification of Manganese Sulfate Monohydrate (1)

500 mL of water was added to the wet material and stirred for 15-20 minutes. 20 g of SC-40 carbon was added to the reaction mass and heated to 55-60° C. The reaction mass was stirred and filtered at 55-60° C. 500 ml of water was added to the reaction mass and cooled to 25-30° C. 1000 g of Indion SIR Na+ resin was charged into a column. 4000 ml of 10% dil. HCl was passed through the resin. 5000.0 mL of water was passed in 5 different portions through the Resin. The reaction mass was passed through the resin. Washed the resin with 200 ml of water. Distilled the collected mass from resin completely at below 75° C. under vacuum to get the pure compound.

### Example-3: Process for the Recrystallization of Manganese Sulfate Monohydrate (1)

250 ml of water was added to the wet material and heated to 70-80° C. Maintained the reaction mass for 30-60 minutes at 70-80° C. and cooled to 25-30° C. 750.0 mL of Ethanol was added slowly at 25-30° C. and Stirred for 1 hour. The obtained solid was filtered, washed with Ethanol, and dried to get the pure compound. Yield: 25.0% to. 30.0%.; XRD: FIG. 1.

### Example-4: Process for the Purification of Commercially Available Manganese Sulfate Monohydrate (1)

500 ml of water was added to the commercially available impure Manganese sulfate monohydrate and stirred for 15-20 minutes. 20 g of SC-40 carbon was added to the reaction mass and heated to 55-60° C. Stirred and filtered the reaction mass at 55-60° C. 500 ml of water was added and cooled to 25-30° C.

1000 g of Indion SIR Na+ resin was charged into a column. 4000 ml of 10% dil. HCl was passed through the resin. 5000.0 ml of water was passed in 5 different portions through the Resin. The reaction mass was passed through the resin. Washed the resin with 200 ml of water. Distilled the collected mass completely at below 75° C. under vacuum to get the pure compound.

Metal component contents of the obtained samples of manganese sulfate monohydrate (percentage by weight) are determined and the results are showed in following table.

| | | Elemental | Limit of | |
|---|---|---|---|---|
| | | results | Quantification | ICH safety limit |
| S. No. | Element | (ppm) | (μg/g) (LOQ) | (ppm) |
| 1. | Lead | 0.004 | 0.125 | 0.5 |
| 2. | Arsenic | Not detected | 0.375 | 1.5 |
| 3. | Cadmium | Not detected | 0.050 | 0.2 |
| 4. | Mercury | 0.003 | 0.075 | 0.3 |
| 5. | Iron | 1.229 | 2.500 | 10 |
| 6. | Zinc | 5.459 | 12.500 | 50 |
| 7. | Aluminium | 14.556 | 125.000 | 500 |

We claim:

1. A method for the synthesis of a high pure Manganese sulfate of formula (1) by iron exchange resin, wherein the manganese sulfate is characterized by at least one of the following parameters:
i) A purity of greater than 99% (w/w);
ii) Less than 0.5 ppm of Lead;
iii) Less than 1.0 ppm of Arsenic;
iv) Less than 0.2 ppm of Cadmium;
v) Less than 0.15 ppm of Mercury;
vi) Less than 2.5 ppm of Iron;
vii) Less than 10 ppm of Zinc; and
viii) Less than 100 ppm of Aluminium

2. A process for producing ultra-high pure Manganese sulfate monohydrate (1), comprising the following steps:
a) dissolving manganese sulfate monohydrate (1) in water;
b) subjecting the reaction mixture to carbon treatment;
c) heating the reaction mixture to a suitable temperature.
d) filtering the reaction mass and diluting with water;
e) cooling the reaction mass and passing the reaction mass through ion exchange resin; and
f) distilling the collected mass to get pure Manganese sulfate monohydrate (1).
wherein the pure manganese sulfate is characterized by at least one of the following parameters:
i) A purity of greater than 99% (w/w);
ii) Less than 0.5 ppm of Lead;
iii) Less than 1.0 ppm of Arsenic;
iv) Less than 0.2 ppm of Cadmium;
v) Less than 0.15 ppm of Mercury;
vi) Less than 2.5 ppm of Iron;
vii) Less than 10 ppm of Zinc; and
viii) Less than 100 ppm of Aluminium

3. The process as claimed in claim 2, wherein resin is selected from Dowex 50W, Amberlite IR-120, Amberjet 1200H, INDION BSR Na+ or INDION SIR Na+.

4. The process as claimed in claim 2, wherein the cation exchange resin is INDION SIR Na+.

5. A process for the recrystallization of Manganese sulfate monohydrate (1), comprising:
1. dissolving Manganese sulfate monohydrate (1) in a water;
2. heating the reaction mass to a suitable temperature;
3. cooling the reaction mass to a suitable temperature;
4. adding anti-solvent to the reaction mass and stirred; and
5. filtering highly pure Manganese sulfate monohydrate (1).

6. The process as claimed in claim 5, wherein the anti-solvent used is selected from methanol, ethanol, propanol, isopropanol, n-butanol, or mixtures thereof.

7. The process as claimed in claim 2 and claim 5, wherein Manganese sulfate monohydrate (1) is prepared by a process comprising:
a) reacting Manganese dioxide with sulphur dioxide gas and water to obtain Manganese sulfate monohydrate crude (1a); and
b) purifying Manganese sulfate monohydrate (1) to obtain Manganese Sulfate Monohydrate (1).
wherein the manganese sulfate is characterized by X-Ray powder diffractogram of FIG. 1.

8. High pure manganese sulfate having X-Ray diffraction pattern as shown in FIG. 1.

9. High pure manganese sulfate of formula (1), wherein the manganese sulfate is characterized by at least one of the following parameters:
i) A purity of greater than 99% (w/w);
ii) Less than 0.5 ppm of Lead;
iii) Less than 1.0 ppm of Arsenic;
iv) Less than 0.2 ppm of Cadmium;
v) Less than 0.15 ppm of Mercury;
vi) Less than 2.5 ppm of Iron;
vii) Less than 10 ppm of Zinc; and
viii) Less than 100 ppm of Aluminium

10. A process A process for the recrystallization of Manganese sulfate comprising the steps of;
a) reacting Manganese dioxide with sulphur dioxide gas and water to obtain Manganese sulfate monohydrate crude (1a); and
b) purifying Manganese sulfate monohydrate (1) by using ion exchange resin to obtain pure Manganese Sulfate (1).
